(19) United States
(12) Patent Application Publication
(10) Pub. No.: US 2004/0198884 A1
(43) Pub. Date: Oct. 7, 2004

(54) Polycarbonate composition with excellent releasability from mold

(76) Inventors: Yuichi Kageyama, Iwakuni-shi Yamaguchi (JP); Takanori Miyoshi, Iwakuni-shi Yamaguchi (JP); Masumi Hirata, Iwakuni-shi Yamaguchi (JP); Wataru Funakoshi, Iwakuni-shi Yamaguchi (JP); Toru Sawaki, Iwakuni-shi Yamaguchi (JP); Katsushi Sasaki, Iwakuni-shi Yamaguchi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/487,395

(22) PCT Filed: Jun. 24, 2002
(86) PCT No.: PCT/JP02/06275

(51) Int. Cl. C08K 5/10; C08K 5/41; C08K 5/49

(52) U.S. Cl. 524/315; 524/155; 524/115

(57) ABSTRACT

A polycarbonate composition comprising 100 parts by weight of an aromatic polycarbonate, 0.005 to 0.2 part by weight of an ester of an aliphatic monocarboxylic acid having 10 to 25 carbon atoms and an aliphatic polyhydric alcohol having 2 to 10 carbon atoms, and 0.015 to 0.3 part by weight of a first aromatic compound which is an aromatic ether, ester or carbonate compound having at least four benzene rings in the molecule, wherein the above ester is contained in the above range to ensure that the first aromatic compound is contained in a deposit on the polymer contacting surface of a metal mold in an amount of 0.5 to 3 parts by weight based on 1 part by weight of the ester when a 120 mm x 50 mm board having a thickness of 2 mm is injection molded at a cylinder temperature of 380° C., a mold temperature of 80° C., an injection speed of 200 mm/sec and a holding pressure of 3,432 kPa (35 kgf/cm²).

This composition has excellent mold releasability and thermal stability at the time of molding.

### FIELD OF THE INVENTION

The present invention relates to a polycarbonate composition having excellent mold releasability, a substrate for optical recording media and an optical recording medium.

### DESCRIPTION OF THE PRIOR ART

Polycarbonates are engineering plastics which are excellent in color, transparency and mechanical strength. In recent years, they have been used in a wide variety of fields and formed into various molded articles. Since they are particularly excellent in mechanical strength, they are used in large quantities as a material for thin molded articles having a high surface area ratio, such as optical disk substrates and housings for electric appliances. Since these molded articles are generally formed by injection molding using a metal mold, it has been apprehended that when the mold releasability of a molded article is low in the step of separating the molded article from the metal mold in the above molding method, production efficiency lowers, which is a more serious problem to be solved as the production scale becomes larger.

Particularly in the case of an optical disk substrate, the cylinder temperature of an injection molding machine is generally set to 350 to 400° C. to improve the fluidity of a resin in order to transfer a signal printed on a stamper to a polycarbonate substrate accurately. Therefore, the temperature of the mold to which the stamper is mounted must be set to 80 to 120° C. However, when the mold temperature is high, such problems arise as a reduction in the mold releasability of a polycarbonate molded article, nonuniform release from the mold and low transcription. To prevent these problems, the mold must be cooled sufficiently before the molded article is separated from the mold. If the mold is cooled sufficiently, the molding cycle will become longer and productivity will lower disadvantageously. For this reason, the development of a polycarbonate having excellent mold releasability for injection molding has been desired.

It has already been known that the addition of a release agent is effective in improving the mold releasability of a polycarbonate. As the release agent are known various compounds called “lubricant”. JP-B 47-41092 (the term “JP-B” as used herein means an “examined Japanese patent publication”) proposes that an ester or partial ester of a higher aliphatic carboxylic acid and a higher aliphatic alcohol or polyhydric alcohol is added as a release agent.

As already known, the addition of a release agent is not desired because it boosts costs and increases the number of steps and it is apprehended that the release agent may have a bad influence upon the characteristic properties polycarbonate such as color, transparency and mechanical strength of a polymer to be produced. In view of the above situation, the development of a method of improving the mold releasability of a polycarbonate without adding a release agent is strongly desired for the simple and cost-effective production of a molded article.

JP-A 6-25523 (the term “JP-A” as used herein means an unexamined published Japanese patent application”) discloses a polycarbonate resin composition which comprises 5 to 95 wt % of a high molecular weight aromatic polycarbonate having a weight average molecular weight of 40,000 to 300,000 and 95 to 5 wt % of a low molecular weight aromatic polycarbonate having a weight average molecular weight of 7,000 to 28,000, has a weight average molecular weight of 20,000 to 50,000 and contains 1.5 wt % or less of a moiety having a molecular weight of 1,000 or less, with a view to providing a polycarbonate resin composition which has excellent fluidity and impact resistance as well as high flexural modulus and heat distortion temperature.

JP-A 8-73724 discloses a polycarbonate resin composition which comprises 100 parts by weight of an aromatic polycarbonate resin having a molecular weight distribution (Mw/Mn) measured by gel permeation chromatography of 2.0 to 2.8 and 0.01 to 0.1 part by weight of a partial ester of an aliphatic carboxylic acid and a polyhydric alcohol, with a view to providing a polycarbonate resin composition which has excellent mold releasability, heat resistance and transcription and is suitable for optical use such as optical disks.

Further, Japanese Patent No. 3124786 discloses an aromatic polycarbonate which has an Mw/Mp of 1.5 or less (Mp is the molecular weight of a peak of a chromatogram measured by gel permeation chromatography) and contains substantially no chlorine, with a view of providing an aromatic polycarbonate which has high fluidity suitable for melt molding and excellent color and melt tension suitable for extrusion molding or blow molding and is free from discoloration or deterioration at the time of molding at a high temperature.

### SUMMARY OF THE INVENTION

It is an object of the present invention to provide a polycarbonate composition which has excellent mold releasability after injection molding in particular.

It is another object of the present invention to provide a polycarbonate composition which has excellent thermal stability at the time of molding in addition to mold releasability.

It is still another object of the present invention to provide a polycarbonate composition which has a low content of the residual phenol and has the above properties.

It is a further object of the present invention to provide a substrate for optical recording media which is made from the polycarbonate composition of the present invention.

It is a still further object of the present invention to provide an optical recording medium comprising the substrate for optical recording media of the present invention.

Other objects and advantages of the present invention will become apparent from the following description.

According to the present invention, firstly, the above objects and advantages of the present invention are attained by a polycarbonate composition comprising:

(1) 100 parts by weight of an aromatic polycarbonate which comprises (i) the main recurring unit represented by the following formula (I):

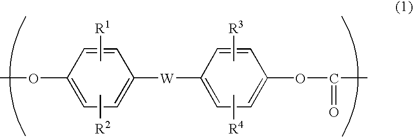

wherein R¹, R², R³ and R⁴ are each independently an alkyl group having 1 to 20 carbon atoms, alkoxy group having 1 to 20 carbon atoms, cycloalkyl group having 6 to 20 carbon atoms, aryl group having 6 to 20 carbon atoms, cycloalkoxy group having 6 to 20 carbon atoms or aryloxy group having 6 to 20 carbon atoms, W is a single bond, oxygen atom, carbonyl group, alkylene group having 1 to 20 carbon atoms, alkylidene group having 2 to 20 carbon atoms, cycloalkylene group having 6 to 20 carbon atoms, cycloalkylidene group having 6 to 20 carbon atoms, arylene group having 6 to 20 carbon atoms or alkylene-arylene-alkylene group having 6 to 20 carbon atoms, and which has (ii) a viscosity average molecular weight of 12,000 to 100,000, (iii) a melt viscosity stability of 0.5% or less, (iv) a terminal OH group content of 5 to 100 chemical equivalents based on 1 ton of the polymer and (v) a ratio of z average molecular weight (Mz) to weight average molecular weight (Mw) of 1.4 to 1.7;

(2) 0.005 to 0.2 part by weight of an ester of an aliphatic monocarboxylic acid having 10 to 25 carbon atoms and an aliphatic polyhydric alcohol having 2 to 10 carbon atoms; and

(3) 0.015 to 0.3 part by weight of a first aromatic compound represented by the following formula (II):

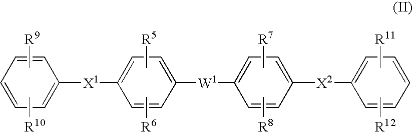

wherein R⁵, R⁶, R⁷ and R⁸ are each independently a group selected from the group consisting of hydrogen atom, alkyl group having 1 to 10 carbon atoms, aryl group having 6 to 20 carbon atoms and aralkyl group having 7 to 20 carbon atoms, R⁹, R¹⁰, R¹¹ and R¹² are each independently a group selected from the group consisting of hydrogen atom and alkyl group having 1 to 10 carbon atoms, W¹ is a member selected from the group consisting of alkylene group having 1 to 6 carbon atoms, alkylidene group having 2 to 10 carbon atoms, cycloalkylene group having 5 to 10 carbon atoms, cycloalkylidene group having 5 to 10 carbon atoms, alkylene-arylene-alkylene group having 8 to 15 carbon atoms, oxygen atom, sulfur atom, sulfoxide group and sulfone group, and X¹ and X² are each independently an ether bond (—O—), ester bond (—COO— or —OCO—) or carbonate bond (—OCOO—),

wherein the above ester is contained in the above range to ensure that when a 120 mm×50 mm board having a thickness of 2 mm is injection molded at a cylinder temperature of 380° C., a mold temperature of 80° C., an injection speed of 200 mm/sec and a holding pressure of 3,432 kPa (35 kgf/cm²), the first aromatic compound is contained in a deposit on the polymer contacting surface of a metal mold in an amount of 0.5 to 3 parts by weight based on 1 part by weight of the above ester.

According to the present invention, secondly, the above objects and advantages of the present invention are attained by a substrate for optical recording media which is made from the aromatic polycarbonate composition of the present invention.

According to the present invention, thirdly, the above objects and advantages of the present invention are attained by an optical recording medium which comprises the above substrate of the present invention and an optical recording layer formed on one side of the substrate directly or through an intermediate layer.

### DETAILED DESCRIPTION OF THE PREFERRED EMBODIMENT

The aromatic polycarbonate (1) used in the present invention comprises the main recurring unit represented by the following formula (I):

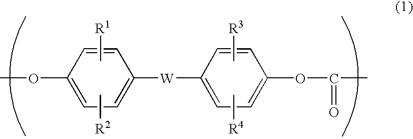

wherein R¹, R², R³ and R⁴ are each independently an alkyl group having 1 to 20 carbon atoms, alkoxy group having 1 to 20 carbon atoms, cycloalkyl group having 6 to 20 carbon atoms, aryl group having 6 to 20 carbon atoms, cycloalkoxy group having 6 to 20 carbon atoms or aryloxy group having 6 to 20 carbon atoms, W is a single bond, oxygen atom, carbonyl group, alkylene group having 1 to 20 carbon atoms, alkylidene group having 2 to 20 carbon atoms, cycloalkylene group having 6 to 20 carbon atoms, cycloalkylidene group having 6 to 20 carbon atoms, arylene group having 6 to 20 carbon atoms or alkylene-arylene-alkylene group having 6 to 20 carbon atoms.

The above aromatic polycarbonate has a viscosity average molecular weight of 12,000 to 100,000, preferably 13,000 to 28,000.

The ratio of z average molecular weight (Mz) to weight average molecular weight (Mw) of the aromatic polycarbonate is in the range of 1.4 to 1.7, preferably 1.45 to 1.6.

The ratio (Mz/Mw) of z average molecular weight (Mz) to weight average molecular weight (Mw) is an important parameter for evaluating the molecular weight distribution of a polymer. When the Mz/Mw is outside the above range, optical distortion or a transcription is readily caused by changes in fluidity or the like. That is, a substrate for optical recording media made from an aromatic polycarbonate having an Mz/Mw within the above range has excellent optical properties and transcription as a substrate for optical recording media.

The molecular weight distribution (Mz/Mw) can be adjusted by the addition of a terminal capping agent or polymerization reaction conditions. For example, in the case of melt polymerization, the charge molar ratio of an aromatic dihydroxy compound to a carbonic acid diester as raw materials is changed or the polymerization conditions (temperature/vacuum degree/residence time) are changed to alter the molecular weight distribution (Mz/Mw). The z average molecular weight can be obtained from a molecular weight distribution measured by gel permeation chromatography.

Further, the aromatic polycarbonate has a melt viscosity stability of 0.5 % or less. The term “melt viscosity stability” is a change rate per minute calculated from an absolute value of change in melt viscosity measured in a stream of nitrogen at a shear rate of 1 rad/sec and 300° C. for 30 minutes.

This melt viscosity stability can be obtained by adding a melt viscosity stabilizer to a polycarbonate after polymerization.

The melt viscosity stabilizer also has the function of deactivating part or all of the activity of the polymerization catalyst used for the production of a polycarbonate.

To add the melt viscosity stabilizer, it may be added while a polycarbonate as a reaction product is molten or after the polycarbonate is pelletized and re-molten. In the former case, it may be added and kneaded while the polycarbonate which is the reaction product in a reactor or an extruder is molten or while the polycarbonate obtained after polymerization is pelletized through the extruder from the reactor.

Any known melt viscosity stabilizer may be used. Sulfonic acid compounds such as organic sulfonic acid salts, organic sulfonic acid esters, organic sulfonic anhydrides and organic sulfonic acid betains are preferred because they have a large effect of improving the physical properties such as color, heat resistance and boiling water resistance of the obtained polymer. Out of these, phosphonium salts of sulfonic acid and/or ammonium salts of sulfonic acid are more preferred. Out of these, tetrabutylphosphonium dodecylbenzenesulfonate (to be abbreviated as DBSP) and tetrabutylammonium paratoluenesulfonate are particularly preferred.

The amount of the melt viscosity stabilizer in the present invention is selected within a range of 0.05 to 20 times the chemical equivalent of an alkali metal or alkali earth metal used as a catalyst.

The amount of the terminal hydroxyl group in the above polycarbonate is 5 to 100 equivalents, preferably 5 to 80 equivalents, more preferably 5 to 60 equivalents, particularly preferably 5 to 50 equivalents based on 1 ton of the polymer. It is judged that when the terminal hydroxyl group is contained in the above range, adhesion between the surface of the mold and the surface of a molded article is controlled to a level for improving mold releasability. Although higher mold releasability is obtained as the amount of the terminal hydroxyl group decreases, when the amount of the terminal hydroxyl group is smaller than 5 equivalents, further improvement of transcription is rare. When the terminal hydroxyl group is introduced in an amount of 100 equivalents or more, a discoloration assumed to be derived from an oxidation reaction at the time of molding is formed on a molded article, which is not preferred for the object of the present invention.

The polycarbonate composition to be injection molded in the present invention may be produced by any polymerization method. A melt polymerization method and a solid-phase polymerization method are preferred from the viewpoints of process, cost including raw materials and no need to use a polymerization solvent such as a halogen-containing solvent and a toxic compound such as phosgene as a carbonic acid ester forming compound. The melt polymerization method is more preferred.

The melt polymerization method is carried out by stirring an aromatic dihydroxy compound and a carbonic acid diester under heating in an inert gas atmosphere under normal pressure or reduced pressure and distilling out the formed alcohol or phenol. The reaction temperature which differs according to the boiling point of the product is generally 120 to 350° C. in order to remove the alcohol or phenol formed by the reaction. For the production of a polycarbonate by the melting method, the inside pressure of the reaction system is gradually reduced to 10 to 100 mmHg while the temperature is gradually raised to 180 to 220° C. in the early stage of the reaction. However, in the polycarbonate production of the present invention, the reaction is preferably carried out by adjusting the inside pressure of the system to 40 to 150 mmHg slightly higher than usual while the temperature is gradually raised to 180 to 220° C. in the early stage of the reaction and making the reaction time longer than usual so as to control the content of the above specific component out of components adhered to the polymer contacting surface of the mold at the time of continuous injection molding to a specific range. The inside pressure of the system is further reduced in the latter stage of the reaction to make it easy to distill out the formed alcohol or phenol. The inside pressure of the system in the latter stage of the reaction is generally 1 mmHg or less.

Examples of the aromatic dihydroxy compound used to produce the polycarbonate of the present invention include 2,2-bis(4-hydroxyphenyl)propane (to be referred to as “bisphenol A” hereinafter), bis(2-hydroxypehnyl)methane, bis(4-hydroxyphenyl)methane, 1,1-bis(4-hydroxyphenyl)ethane, 1,1-bis(4-hydroxyphenyl)propane, 2,2-bis(2-hydroxyphenyl)propane, 2,2-bis(4-hydroxy-3,5-dimethylphenyl)propane, 2,2-bis(4-hydroxy-3,5-dibromophenyl)propane, 2,2-bis(4-hydroxy-3-methylphenyl)propane, 2,2-bis(4-hydroxyphenyl)pentane, 3,3-bis(4-hydroxyphenyl)pentane, 1,1-bis(4-hydroxyphenyl)cyclohexane, bis(4-hydroxyphenyl)sulfide, bis(4-hydroxyphenyl)sulfone and what are obtained by substituting an aromatic ring thereof by an alkyl group or aryl group. They may be used alone or in combination of two or more. Out of these, bisphenol A is particularly preferred from an economical point of view.

Examples of the carbonic acid diester include diphenyl carbonate, dinaphthyl carbonate, bis(diphenyl)carbonate, dimethyl carbonate, diethyl carbonate and dibutyl carbonate. Out of these, diphenyl carbonate is particularly preferred from an economical point of view.

In the present invention, a polymerization catalyst may be used to accelerate the polymerization rate. The polymerization catalyst is preferably an alkali metal compound or an alkali earth metal compound. The compound is, for example, a hydroxide, hydrocarbon compound, carbonate, acetate, nitrate, nitrite, sulfite, cyanate, thiocyanate, stearate, borohydride, benzoate, phosphate, acidic phosphate, bisphenol or phenol salt of an alkali metal or an alkali earth metal.

Illustrative examples of the compound include sodium hydroxide, potassium hydroxide, lithium hydroxide, cesium hydroxide, rubidium hydroxide, francium hydroxide, sodium bicarbonate, potassium bicarbonate, lithium bicarbonate, sodium carbonate, potassium carbonate, lithium carbonate, cesium carbonate, sodium acetate, potassium acetate, lithium acetate, sodium nitrate, potassium nitrate, rubidium nitrate, lithium nitrate, sodium nitrite, potassium nitrite, rubidium nitrite, lithiumnitrite, sodium sulfite, potassium sulfite, lithium sulfite, sodium cyanate, potassium cyanate, lithium cyanate, sodium thiocyanate, potassium thiocyanate, lithium thiocyanate, cesium thiocyanate, sodium stearate, potassium stearate, lithium stearate, cesium stearate, sodium borohydride, potassium borohydride, lithium borohydride, sodium phenylborate, sodium benzoate, potassium benzoate, lithium benzoate, disodium hydrogenphosphate, dipotassium hydrogenphosphate, dilithium hydrogenphosphate, disodium salts, dipotassium salts, dilithium salts, dicesium salts, monosodium salts, monopotassium salts, monocesium salts, sodium potassium salts and sodium lithium salts of bisphenol A and sodium salts, potassium salts and lithium salts of phenol. Out of these, cesium compounds and rubidium compounds are preferred.

The alkali metal compound preferably contains at least one selected from the group consisting of a cesium compound and a rubidium compound, and cesium and/or rubidium metal atoms contained in the alkali metal compound account for preferably 0.001 to 100%, more preferably 90 to 100% of the total of all the alkali metal atoms.

The amount of the polymerization catalyst is preferably 0.05 to 5 p-chemical equivalents, more preferably 0.07 to 3 μ-chemical equivalents, particularly preferably 0.07 to 2 μ-chemical equivalents based on 1 mol of the aromatic dihydroxy compound.

The alkali metal compound and the alkali earth metal compound are preferably used in combination with a nitrogen-containing basic compound and/or a phosphorus-containing basic compound. A polycarbonate having excellent color and thermal stability can be obtained at a high polymerization rate by using this combination.

Illustrative examples of the nitrogen-containing basic compound include ammonium hydroxides having an alkyl, aryl or aralkyl group such as tetramethylammonium hydroxide (Me₄NOH), tetraethylammonium hydroxide (Et₄NOH), tetrabutylammonium hydroxide (Bu₄NOH), benzyltrimethylammonium hydroxide (PhCH₂(Me)₃NOH) and hexadecyltrimethylammonium hydroxide; basic ammonium salts having an alkyl, aryl or alkylaryl group such as tetramethylammonium acetate, tetraethylammonium phenoxide, tetrabutylammonium carbonate, benzyltrimethylammonium benzoate and hexadecyltrimethylammonium ethoxide; tertiary amines such as triethylamine, tributylamine, dimethylbenzylamine and hexadecyl dimethylamine; and basic salts such as tetramethylammonium borohydride (Me₄NBH₄), tetrabutylammonium borohydride (BU₄NBH₄), tetrabutylammonium tetraphenyl borate (Bu₄NBPh₄) and tetramethylammonium tetraphenyl borate (Me₄NBPh₄).

Illustrative examples of the phosphorus-containing basic compound include phosphonium hydroxides having an alkyl, aryl or alkylaryl group such as tetramethylphosphonium hydroxide (Me₄POH), tetraethylphosphonium hydroxide (Et₄POH), tetrabutylphosphonium hydroxide (Bu₄POH), tetraphenylphosphonium hydroxide (Ph₄POH), benzyltrimethylphosphonium hydroxide (PhCH₂(Me)₃POH) and hexadecyltrimethylphosphonium hydroxide; and basic salts such as tetramethylphosphonium borohydride (Me₄PBH₄), tetrabutylphosphonium borohydride (BU₄PBH₄), tetrabutylphosphonium tetraphenyl borate (Bu₄PBPh₄) and tetramethylphosphonium tetraphenyl borate (Me₄PBPh₄).

The above nitrogen-containing basic compound and/or phosphorus-containing basic compound are/is preferably used in an amount of 10 to 1,000 μ-chemical equivalents in terms of basic nitrogen atom or basic phosphorus atom based on 1 mol of the aromatic dihydroxy compound. The amount is more preferably 20 to 500 μ-chemical equivalents, particularly preferably 50 to 500 μ-chemical equivalents based on the same standard.

In the present invention, the melt viscosity stability of a molten polymer must be adjusted to 0.5% or less as described above to improve stability under various conditions of the polymer after polymerization in order to obtain a polycarbonate composition having excellent stability which is almost free from a reduction in molecular weight and discoloration after injection molding. To this end, a melt viscosity stabilizer is preferably used after polymerization. The melt viscosity stability is a change rate per minute calculated from an absolute value of change in melt viscosity measured in a stream of nitrogen at a shear rate of 1 rad/sec and 300° C. for 30 minutes.

The melt viscosity stabilizer in the present invention has the function of deactivating part or all of the activity of a polymerization catalyst used for the production of a polycarbonate.

The melt viscosity stabilizer may be added while the polycarbonate as a reaction product is molten or after the polycarbonate is pelletized and re-molten. In the former case, it may be added and kneaded while the polycarbonate which is the reaction product in a reactor or an extruder is molten or while the polycarbonate obtained after polymerization is pelletized through the extruder from the reactor.

Any known melt viscosity stabilizer may be used. Sulfonic acid compounds such as organic sulfonic acid salts, organic sulfonic acid esters, organic sulfonic anhydrides and organic sulfonic acid betains are preferred because they have a large effect of improving the physical properties such as color, heat resistance and boiling water resistance of the obtained polymer.

Out of these, a sulfonic acid compound represented by the following formula (IV) is preferred:

A¹-SO₃X¹ (IV)

wherein A¹ is a monovalent hydrocarbon group having 1 to 30 carbon atoms which may be substituted, and X¹ is an ammonium cation, phosphonium cation or monovalent hydrocarbon group having 1 to 10 carbon atoms.

By containing this, the activity of an alkali metal or alkali earth metal compound used as an ester exchange catalyst can be reduced or deactivated, thereby making it possible to obtain a polycarbonate having excellent quality such as color, heat resistance and hydrolytic resistance.

The sulfonic acid compound is more preferably a sulfonic acid phosphonium salt represented by the following formula (IV)-1 because it has a large effect:

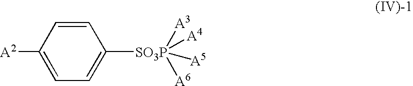

wherein A², A³, A⁴, A⁵ and A⁶ are each independently a monovalent hydrocarbon group having 1 to 20 carbon atoms.

A² in the above formula (IV)-1 is selected from hydrogen atom, methyl group, hexyl group and dodecyl group, and A³ to A⁶ are each independently selected from methyl group, butyl group and octyl group.

The sulfonic acid compound functions as a deactivator for the residual ester exchange catalyst contained in the polymer. Known catalyst deactivators disclosed by JP-A 8-59975 are also effectively used. Out of these, ammonium salts of sulfonic acid and phosphonium salts of sulfonic acid are preferred. More specifically, ammonium salts and phosphonium salts of dodecylbenzenesulfonic acid, ammonium salts and phosphonium salts of paratoluenesulfonic acid, and ammonium salts and phosphonium salts of benzenesulfonic acid are preferred.

Out of these catalyst deactivators, sulfonic acid compounds of the above formula (IV)-1, particularly tetrabutylphosphonium dodecylbenzenesulfonate and tetrabutylammonium paratoluenesulfonate are the most preferably used in the present invention.

The catalyst deactivator is used to greatly reduce the activity of a catalyst and may be added to a polycarbonate resin alone or as a mixed solution of it and water.

The amount of the catalyst deactivator to be added to the polycarbonate resin obtained by melt polycondensation is 0.5 to 50 mols, preferably 0.5 to 10 mols, more preferably 0.8 to 5 mols based on 1 mol of the above main polycondensation catalyst selected from an alkali metal compound and an alkaline earth metal compound. In other words, it is used in an amount of 1×10⁻⁵ to 1×10⁻² part by weight based on 100 parts by weight of the polycarbonate resin.

The polycarbonate composition of the present invention contains an ester of an aliphatic monocarboxylic acid having 10 to 25 carbon atoms and an aliphatic polyhydric alcohol having 2 to 10 carbon atoms in an amount of 0.005 to 0.2 part by weight based on 100 parts by weight of the above polycarbonate. The amount of the ester of an aliphatic monocarboxylic acid having 10 to 25 carbon atoms and an aliphatic polyhydric alcohol having 2 to 10 carbon atoms is preferably 0.005 to 0.1 part by weight, more preferably 0.0075 to 0.07 part by weight, particularly preferably 0.01 to 0.05 part by weight based on 100 parts by weight of the polycarbonate to obtain more excellent mold releasability.

When the amount of the ester moiety of the above material is smaller than 0.005 part by weight, desired mold releasability is not obtained and when the amount is larger than 0.2 part by weight, the surface properties of a molded article deteriorate or the metal mold is contaminated disadvantageously.

The aliphatic monocarboxylic acid having 10 to 25 carbon atoms in the present invention includes an aliphatic linear or branched carboxylic acid or a saturated or unsaturated carboxylic acid. Specific examples of the aliphatic monocarboxylic acid include linear carboxylic acids such as lauric acid, myristic acid, palmitic acid, stearic acid and behenic acid, and branched aliphatic acids such as isodecanoic acid, isotridecanoic acid, isomyristic acid, isopalmitic acid, isostearic acid, isoarachic acid and isohexacosanoic acid. Unsaturated carboxylic acids such as oleic acid, linoleic acid, linolenic acid, 5,8,11,14-eicosatetraenoic acid and 4,7,10,13,16,19-docosahexaenoic acid may also be used.

Examples of the aliphatic polyhydric alcohol having 2 to 10 carbon atoms in the present invention include ethylene glycol, propylene glycol, 1,3-propylene glycol, 1,4-butanediol, glycerol, trimethylolpropane, pentaerythritol, dipentaerythritol, 1,4-butenediol, sorbitol, sorbitan and saccharose.

The ester of the aliphatic monocarboxylic acid and the aliphatic polyhydric alcohol is, for example, an ester of at least one of the above aliphatic monocarboxylic acids and at least one of the above aliphatic polyhydric alcohols.

Specific examples of the ester include ethylene glycol monoisopalmitate, ethylene glycol distearate, propylene glycol dioleate, propylene glycol monoisomyristate, 1,4-butanediol diisopalmitate, 1,4-butenediol diisostearate, 1,4-butenediol monostearate, 1,4-butenediol distearate, glycerol monolaurate, glycerol monomyristate, glycerol monostearate, glycerol monobehenate, glycerol monoisomyristate, glycerol monoisostearate, glycerol monooleate, glycerol monolinoleate, glycerol dipalmitate, glycerol distearate, glycerol diisopalmitate, glycerol duisostearate, glycerol dioleate, glycerol stearate isopalmitate, glycerol trimyristate, glycerol tristearate, glycerol tribehenate, glycerol triisostearate, trimethylolpropane monostearate, trimethylolpropane monobehenate, trimethylolpropane monoisopalmitate, trimethylolpropane monooleate, trimethylolpropane dipalmitate, trimethylolpropane diisostearate, trimethylolpropane tristearate, trimethylolpropane triisomyristate, trimethylolpropane trioleate, pentaerythritol monopalmitate, pentaerythritol diisopalmitate, pentaerythritol trioleate, pentaerythritol tetrastearate, pentaerythritol tetraisopalmitate, pentaerythritol dioleate distearate, sorbitan monostearate and saccharose diisostearate.

Out of these, glycerol, trimethylolpropane and pentaerythritol esters are preferred.

The first aromatic compound contained in the composition of the present invention is represented by the following formula (II):

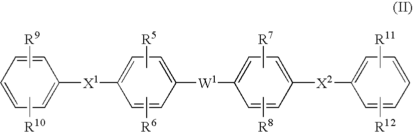

In the above formula, R⁵, R⁶, R⁷ and R⁸ are each independently a group selected from the group consisting of hydrogen atom, alkyl group having 1 to 10 carbon atoms, aryl group having 6 to 20 carbon atoms and aralkyl group having 7 to 20 carbon atoms, R⁹, R¹⁰, R¹¹ and R¹² are each independently a group selected from the group consisting of hydrogen atom and alkyl group having 1 to 10 carbon atoms, W¹ is a member selected from the group consisting of alkylene group having 1 to 6 carbon atoms, alkylidene group having 2 to 10 carbon atoms, cycloakylene group having 5 to 10 carbon atoms, cycloalkylidene group having 5 to 10 carbon atoms, alkylene-arylene-alkylene group having 8 to 15 carbon atoms, oxygen atom, sulfur atom, sulfoxide group and sulfone group, and X¹ and X² are each independently an ether bond (—O—), ester bond (—COO— or —OCO—) or carbonate bond (—OCOO—).

Examples of the groups representing R⁵ to R¹² and W¹ in the above formula (II) are obvious from examples given for R¹ to R⁴ and W in the above formula (I).

The above first aromatic compound is preferably a compound represented by the following formula (II)-1:

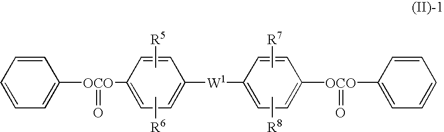

wherein R⁵ to R⁸ and W¹ are as defined in the above formula (II),

for example, a compound represented by the following formula.

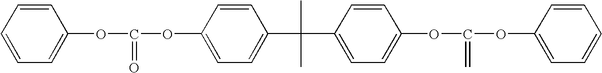

The first aromatic compound is contained in an amount of 0.015 to 0.3 part by weight, preferably 0.016 to 0.28 part by weight, more preferably 0.017 to 0.25 part by weight based on 100 parts by weight of the aromatic polycarbonate.

The composition of the present invention is suitably determined by the amounts of the above ester and the first aromatic compound seen in a deposit on the polymer contacting surface of a metal mold when a 120 mm×50 mm board having a thickness of 2 mm is injection molded using the above ester of an aliphatic monocarboxylic acid and an aliphatic polyhydric alcohol and the above first aromatic compound at a cylinder temperature of 380° C., a mold temperature of 80° C., an injection speed of 200 mm/sec and a holding pressure of 3,432 KPa (35 kgf/cm²). That is, the above ester is used in the above range to ensure that the first aromatic compound is contained in the deposit in an amount of 0.5 to 3 parts by weight, preferably 0.6 to 2.8 parts by weight based on 1 part by weight of the ester.

When the ester and the first aromatic compound are contained in the deposit in the above ratio, desired mold releasability is obtained and a molded article free from an ill effect on its color and mechanical properties is obtained.

The composition of the present invention may further comprise a second aromatic compound represented by the following formula (III):

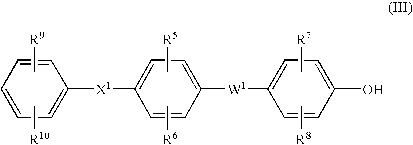

wherein R⁵ to R¹⁰, X¹ and W¹ are as defined in the above formula

The compound of the above formula (III) is preferably a compound represented by the following formula (III)-1:

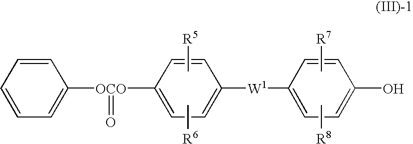

wherein R⁵ to R⁸ and W¹ are as defined in the above formula (III),

for example, a compound represented by the following formula.

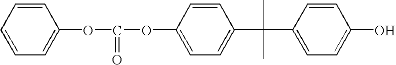

The second aromatic compound is contained in an amount of preferably 0.01 to 0.1 part by weight, more preferably 0.011 to 0.095 part by weight, particularly preferably 0.012 to 0.09 part by weight based on 100 parts by weight of the aromatic polycarbonate.

The above ester of an aliphatic monocarboxylic acid and an aliphatic polyhydric alcohol and the above second aromatic compound are used to ensure that the second aromatic compound is contained in the above deposit in an amount of preferably 2.5 to 10 parts by weight, more preferably 2.6 to 9.5 parts by weight based on 1 part by weight of the ester.

Further, when the second aromatic compound represented by the above formula (III) is contained in an amount of preferably 0.5 to 50 parts by weight, more preferably 0.5 to 2.5 parts by weight, particularly preferably 0.5 to 2.0 parts by weight based on 1 part by weight of the first aromatic compound represented by the above formula (II), more desired mold releasability is obtained.

Methods of controlling the contents of the first aromatic compound and optionally the second aromatic compound to the above ranges include one in which the compounds are synthesized and controlled simultaneously with a polymerization reaction by maintaining temperature and the degree of vacuum at appropriate levels under conditions for the former stage of a melt polymerization reaction and/or conditions for the latter stage of the melt polymerization reaction for the production of a polycarbonate, one in which the compounds synthesized separately are mixed with a molten polycarbonate in the final stage of polymerization, and one in which the compounds are mixed when the polycarbonate is solidified and re-molten after the end of polymerization. The method in which the compounds are synthesized and controlled during a melt polymerization reaction is preferred.

Methods of controlling the weight ratio to the above range include one in which the molar ratio of a carbonic acid diester to an aromatic dihydroxy compound at the time of charging for a polymerization reaction is increased (for example, to 1.03 to 1.10 to carry out polymerization; polymerization charge molar ratio control method) in consideration of the characteristic features of a polymerization reactor and/or one in which OH terminal groups are capped by a salicylate-based compound at the end of a polymerization reaction in accordance with a method disclosed by U.S. Pat. No. 5,696,222.

The contents of these compounds in the polymer can be measured by known methods such as one in which an organic low-molecular weight compound extracted by a polymer reprecipitation method is measured by high-speed liquid chromatography to determine the amount of the compound and one in which an organic solvent having high solubility for an organic low-molecular weight compound but no solubility for a polycarbonate is used to carry out Soxhlet extraction to determine the amount of an organic low-molecular weight compound by distilling off the solvent. The former method is more preferred.

The aromatic polycarbonate composition of the present invention may further comprise a phosphorous acid ester and/or a phosphoric acid ester as an optional component in an amount of 1×10⁻⁴ to 0.1 part by weight based on 100 parts by weight of the aromatic polycarbonate.

Examples of the phosphorous acid ester include trialkyl phosphites such as trimethyl phosphate, triethyl phosphite, tributyl phosphite, trioctyl phosphate, tris(2-ethylhexyl)phosphite, trinonyl phosphate, tridecyl phosphate, trioctadecyl phosphate and tristearyl phosphite, tricycloalkyl phosphates such as tricyclohexyl phosphate, triaryl phosphates such as triphenyl phosphite, tricresyl phosphite, tris(ethylphenyl)phosphite, tris(2,4-di-t-butylphenyl)phosphite, tris(nonylphenyl)phosphite and tris(hydroxyphenyl)phosphite, and arylalkyl phosphites such as phenyldidecyl phosphate, diphenyldecyl phosphite, diphenylisooctyl phosphite, phenylisooctyl phosphite and 2-ethylhexyldiphenyl phosphate.

Further, distearyl pentaerythrityl diphosphite and bis(2,4-di-t-butylphenyl)pentaerythrityl diphosphite may also be used as the phosphorous acid ester.

Examples of the phosphoric acid ester include trialkyl phosphates such as trimethyl phosphate, triethyl phosphate, tributyl phosphate, trioctyl phosphate, tridecyl phosphate, trioctadecyl phosphate and distearyl pentaerythrityl diphosphate, tricycloalkyl phosphates such as tricyclohexyl phosphate, and triaryl phosphates such as triphenyl phosphate, tricresyl phosphate, tris(nonylphenyl)phosphate and 2-ethylphenyldiphenyl phosphate.

These compounds may be used alone or in combination of two or more. Out of these, aromatic phosphorous acid esters are preferred.

The phosphorous acid ester and/or phosphoric acid ester are/is contained in an amount of preferably 1×10⁻³ to 5×10⁻² part by weight based on 100 parts by weight of the aromatic polycarbonate (A).

Further, the aromatic polycarbonate composition of the present invention may further comprise at least one compound selected from the group consisting of hydrochloric acid, phosphoric acid, phosphorous acid, boric acid, and amine salts and ammonium salts thereof in an amount of 1×10⁻⁵ to 1×10⁻² part by weight based on 100 parts by weight of the aromatic polycarbonate (A) as an optional component.

Use of these optional components is effective in eliminating inconvenience such as discoloration, deterioration or the formation of a silver streak in the polycarbonate resin composition at the time of melt molding at a high temperature, particularly 300° C. or higher.

The amine constituting the above amine salts is a secondary amine such as dimethylamine, diethylamine, dibutylamine, dioctylamine, dilaurylamine, piperazine, piperidine or cyclobutylamine; or tertiary amine such as trimethylamine, triethyamine, tributylamine or pyridine.

The amount of each of the above compounds as optional components is preferably 1×10⁻⁴ to 5×10⁻³ part by weight based on 100 parts by weight of the aromatic polycarbonate.

To the above aromatic polycarbonate composition of the present invention may be added a conventionally known release agent, processing stabilizer, heat resistant stabilizer, antioxidant, optical stabilizer, ultraviolet light absorber, metal inactivating agent, metal soap, nucleating agent, antistatic agent, flame retardant and the like according to application purpose.

Conventionally known release agents are a partial ester compound of an aliphatic carboxylic acid and a polyhydric alcohol, that is, an ester compound having at least one unreacted and free hydroxyl group of the polyhydric alcohol.

The above aliphatic carboxylic acid is not particularly limited and may be a saturated or unsaturated aliphatic carboxylic acid. The aliphatic carboxylic acid is preferably a saturated monovalent fatty acid, particularly preferably a saturated monovalent fatty acid having 12 to 24 carbon atoms.

Examples of the aliphatic carboxylic acid include dodecylic acid, pentadecylic acid, palmitic acid, heptadecylic acid, stearic acid, nonadecanoic acid, arachic acid, behenic acid and lignoceric acid.

The above polyhydric alcohol is not particularly limited and may be divalent, trivalent, tetravalent, pentavalent or hexavalent. Examples of the polyhydric alcohol include ethylene glycol, propylene glycol, neopentyl glycol, glycerin, trimethylolpropane and pentaerythritol. Out of these, glycerin is particularly preferred.

The above partial ester compound is preferably a saturated monovalent aliphatic monoglyceride and/or diglyceride having 12 to 24 carbon atoms.

The above partial ester compound is desirably used to ensure that the weight ratio of the epoxy compound represented by the above formula (I) to the partial ester compound is preferably 0.25 to 5, more preferably 0.42 to 1.

Examples of the processing stabilizer include 2-t-butyl-6-(3-t-butyl-2-hydroxy-5-methylbenzyl)-4-methylphenyl acrylate and 2-[1-(2-hydroxy-3,5-di-t-pentylphenyl)ethyl]-4,6-di-t-pentylphenyl acrylate.

Examples of the optical stabilizer include ultraviolet light absorbers such as benzotriazole-based compounds including 2-(3-t-butyl-2-hydroxy-5-methylphenyl)-5-chlorobenzotriazole, 2-(3,5-di-t-butyl-2-hydroxyphenyl)benzotriazole, 2-(2-hydroxy-5-methylphenyl)benzotriazole, 2-(2-hydroxy-5-t-octylphenyl)benzotriazole, 2-(3,5-di-t-pentyl-2-hydroxyphenyl)benzotriazole, 2-[2-hydroxy-3-(3,4,5,6-tetrahydrophthalimidomethyl) phenyl]benzotriazole and 2-[2-hydroxy-3,5-bis(α,α-dimethylbenzyl)phenyl]benzotriazole; benzophenone-based compounds including 2-hydroxy-4-octyloxybenzophenone and 2-hydroxy-4-methoxybenzophenone; hydroxybenzophenone-based compounds including 2,4-di-t-butylphenyl and 3,5-di-t-butyl-4-hydroxybenzoate; and cyanoacrylate-based compounds including ethyl-2-cyano-3,3-diphenyl acrylate, and nickel-based quenchers such as nickel dibutyldithiocarbamate and [2,2α-thiobis(4-t-octylphenolate)]-2-ethylhexylamine nickel.

Examples of the metal inactivating agent include N,Nα-[3-(3,5-di-t-butyl-4-hydroxyphenyl)propionyl]hydrazine, and examples of the metal soap include calcium stearate and nickel stearate.

Examples of the nucleating agent include sorbitol-based and phosphate-based compounds such as sodium di(4-t-butylphenyl)phosphonate, dibenzylidene sorbitol and methylenebis(2,4-di-t-butylphenol)acid phosphate sodium salt.

Examples of the antistatic agent include quaternary ammonium salt- and alkylphosphate-based compounds such as (β-lauramidepropyl)trimethylammonium methyl sulfate.

Examples of the flame retardant include halogen-containing phosphoric acid esters such as tris(2-chloroethyl)phosphate, halides such as hexabromocyclododecane and decabromophenyl oxide, metal inorganic compounds such as antimony trioxide, antimony pentaoxide and aluminum hydroxide, and mixtures thereof.

The above components may be added to and kneaded with a molten polycarbonate, or may be added to and kneaded with a polycarbonate solution. More specifically, they are directly added to and kneaded with the molten polycarbonate which is the reaction product in a reactor or extruder obtained after the end of a polymerization reaction, or the obtained polycarbonate is pelletized and supplied into a single-screw or double-screw extruder together with the components to be melt kneaded together, or the obtained polycarbonate is dissolved in a suitable solvent (such as methylene chloride, chloroform, toluene or tetrahydrofuran) and the components are added to the resulting solution and stirred. In order to reduce the heat history time of the polycarbonate in a molten state and the number of times of re-melting the polycarbonate, it is preferred to add and knead the components such as a sulfonic acid compound and a cyclic compound with the molten polycarbonate obtained by melt polymerization and then pelletize the obtained product.

The polycarbonate composition of the present invention can be formed into various molded articles by injection molding. Injection molding may be carried out by using any apparatus but the cylinder temperature of the molding machine is preferably set to 250 to 400° C. When the cylinder temperature is lower than 250° C., a satisfactory molded article cannot be obtained because the fluidity of the polymer is low. Particularly in the case of molding an optical disk substrate which is one of the major application fields of the polycarbonate, the transcription of a stamper signal lowers disadvantageously. When the cylinder temperature is higher than 400° C., the thermal deterioration of the polymer occurs, thereby greatly worsening its color and mechanical properties disadvantageously. The mold temperature is preferably set to 50 to 140° C. When the mold temperature is lower than 50° C., the molded article cannot be separated uniformly and when the mold temperature is higher than 140° C., desired mold releasability is not obtained.

According to the present invention, an injection molded article can be separated from the mold smoothly by the mold release function of the first aromatic compound when the first aromatic compound represented by the above formula (II) is adhered to the aromatic polycarbonate contacting surface of an injection metal mold for containing the aromatic polycarbonate in an amount of 0.005 to 0.1 mg per 1 cm² of the mold surface at the time of injection molding the article.

The molded articles of the aromatic polycarbonate composition of the present invention include electronic and communication equipment; OA equipment; optical parts such as lenses, prisms, substrates for optical recording media such as optical disk substrates, and optical fibers; electronic and electric materials such as home electric appliances, lighting members and heavy electric members; mechanical materials such as car interiors and exteriors, precision machinery and insulating materials; medical materials; security and protective materials; sport and leisure goods; miscellaneous goods such as household utensils; containers and packing materials; and display and ornament materials. The above optical disk substrates include substrates having a thickness of 1.2 mm for CD, LD, CD-ROM, CD-R, optomagnetic disks and phase-variable disks, substrates obtained by laminating together two molded substrates having a thickness of 1.2 mm, substrates having a thickness of 0.6 mm, and DVD substrates obtained by laminating together two molded substrates for DVD having a thickness of 0.6 mm. The DVD substrates include DVD-ROM, DVD-R and DVD-RAM substrates.

The substrate for optical recording media of the present invention preferably has a critical surface tension of 34.8 to 36.4.

According to the present invention, there are provided a substrate for optical recording media which is made from the polycarbonate composition of the present invention and an optical recording medium which comprises the above substrate for optical recording media and an optical recording layer formed on one side of the substrate directly or through an intermediate layer.

This optical recording medium may comprise a dielectric layer and an anti-reflection layer as required like known optical recording media.

### EXAMPLES

The following examples are provided for the purpose of further illustrating the present invention but are in no way to be taken as limiting. The polymer was evaluated by the following methods.

(1) Viscosity Average Molecular Weight (Mv)

The intrinsic viscosity [η] was measured in methylene chloride at 20° C. to obtain viscosity average molecular weight from the following expression.

[η]=1.23×10⁻⁴×MW^{0.83}

(2) Molecular Weight Distribution

This was measured using the gel permeation chromatograph (shodeXGPC System-11) of Showa Denko K.K.

(3) Concentration of Terminal OH Group

The proportion of the amount of the terminal OH group to the total amount of all the terminal groups was calculated by measuring with the high-resolution NMR (EX-270) of JEOL Corporation.

(4) Measurement of Critical Surface Tension

This was measured in accordance with JIS K6768. That is, the surface tension of a molded board (30 to 56 dyn/cm; 330 to 560 μN/cm) was measured using a wetting test solution (mixed solution of formamide and ethylene glycol monomethyl ether; Wako Pure Chemical Industries, Ltd.) and a color coupler (Victoria Blue B; Wako Pure Chemical Industries, Ltd.). 30 sample molded boards were used for each polymer and measured at 5 points, and the measurement data were averaged.

(5) Mold Releasability

100 compact disk substrates were molded continuously and the number of shots leaving the residue on a disk or sprue mold was evaluated as a defective rate (%)

(6) Transcription

Pits transferred to the disk substrates obtained by the above method were observed through an optical microscope (X800) and evaluated. 100 disks were evaluated for each Example and Comparative Example.

More specifically, it was evaluated whether the shapes of the transferred pits were abnormal or not. The expression “nonuniform in shape” means that the pits transferred to the disk substrate are nonuniform in shape, namely, a micron-order transfer is a failure.

(7) Thermal Stability

The obtained pellet was retained in an injection molding machine (cylinder temperature of 340° C., mold temperature of 80° C.) for 5 minutes and then a 2 mm-thick board was molded therefrom. The color difference before and after retention (AE) was measured with the color meter of Nippon Denshoku Kogyo Co., Ltd.

### Examples 1, 2 and 3 and Comparative Example 1

228 parts by weight of bisphenol A (to be abbreviated as BPA hereinafter), 223 parts by weight of diphenyl carbonate (to be abbreviated as DPC hereinafter), 0.009 part by weight of tetramethylammonium hydroxide and 0.00014 part by weight of bisphenol A disodium salt were fed to a reactor equipped with a stirrer, distillation column and decompressor, the inside of the reactor was substituted with nitrogen, and the above components were dissolved at 140° C. After 30 minutes of stirring, the inside temperature of the reactor was raised to 205° C. to carry out a reaction at an inside pressure of 100 mmHg for 50 minutes, and the formed phenol was distilled off. Then, the inside pressure was gradually reduced to 20 mmHg while the inside temperature was raised to 240° C. to further continue the reaction at the same temperature and the same pressure for 70 minutes. Finally, the temperature was raised to 270° C. to continue the polycondensation of a polycarbonate at an inside pressure of 1 mmHg. The viscosity average molecular weight of the obtained polycarbonate was 15,200. This polymer was supplied into a double-screw extruder (L/D=17.5, barrel temperature of 270° C.) in a molten state by a gear pump, predetermined amounts of an ester compound, acid, sulfonic acid compound and phosphorous acid ester shown in the table were added to and kneaded with the polymer, and the resulting mixture was let pass through a die to form a strand which was then cut with a cutter to form pellets.

### Example 4

The procedure of Example 1 was repeated except that the operation of adding 2 parts by weight of DPC to the reaction system was inserted after the temperature was raised to 270° C.

### Example 5

The procedure of Example 1 was repeated except that 0.00004 part by weight of cesium hydroxide was used in place of 0.00014 part by weight of the bisphenol A disodium salt.

### Comparative Example 2

The procedure of Example 1 was repeated except that 231 parts by weight of DPC and 0.0003 part by weight of bisphenol A disodium salt were used in place of 223 parts by weight of DPC and 0.009 part by weight of tetramethylammonium hydroxide, respectively, to continue the polycondensation of a polycarbonate at 300° C. in the end.

### Comparative Example 3

The procedure of Example 1 was repeated except that 231 parts by weight of DPC was used in place of 223 parts by weight of DPC.

TABLE 1

| | | Ex. 1 | Ex. 2 | Ex. 3 | Ex. 4 |
|---|---|---|---|---|---|
| Polymerization catalyst | | BPANa | BPANa | BPANa | BPANa |
| Content of ester compound (ppm) | | glycerin | glycerin | propylene glycol | glycerin |
| | | monostearate | monostearate | monopalmitate | monostearate |
| | | 350 | 200 | 500 | 350 |
| content of first aromatic | | 400 | 400 | 400 | 500 |
| compound (ppm) | | | | | |
| content of second aromatic | | 1200 | 1200 | 1200 | 800 |
| compound (ppm) | | | | | |
| content of acid (ppm) | | phosphoric acid 5 | phosphoric acid 5 | — | phosphoric acid 5 |
| content of sulfonic acid compound | | DBSP | DBSP | DBSP | DBSP |
| (ppm) | | 10 | 10 | 10 | 10 |
| content of phosphorous acid ester | | TTBPP | TTBPP | TTBPP | TTBPP |
| (ppm) | | 50 | 50 | 100 | 50 |
| characteristic | Mv | 15200 | 15200 | 15200 | 15200 |
| properties of | Mz/Mw | 1.50 | 1.50 | 1.50 | 1.50 |
| pellet | melt viscosity | <0.1% | <0.1% | <0.1% | <0.1% |
| | stability | | | | |
| | terminal OH eq/Ton | 25 | 25 | 25 | 20 |

| | | | | | | | |
|---|---|---|---|---|---|---|---|
| molding | deposit on | amount | ester compound | 180 | 130 | 280 | 180 |
| results | metal | (μg/cm²) | first aromatic | 250 | 255 | 250 | 280 |
| | mold | | compound | 760 | 760 | 760 | 540 |
| | (μg/cm²) | | second aromatic | | | | |
| | | | compound | | | | |
| | | ratio | first aromatic | 1.4 | 2.0 | 0.9 | 1.6 |
| | | | compound/ester | | | | |
| | | | compound | | | | |
| | | | second aromatic | 4.2 | 5.8 | 2.7 | 3.0 |
| | | | compound/ester | | | | |
| | | | compound | | | | |

| | | | | |
|---|---|---|---|---|
| critical surface tension of mold surface | 37.8 | 37.8 | 37.8 | 35.0 |
| mold releasability (defective ratio %) | 0 | 1 | 0 | 0 |
| transcription | all | all | all | all |
| | satisfactory | satisfactory | satisfactory | satisfactory |
| thermal stability (ΔE) | 0.3 | 0.2 | 0.2 | 0.3 |

| | | Ex. 5 | C.Ex. 1 | C.Ex. 2 | C.Ex. 3 |
|---|---|---|---|---|---|
| Polymerization catalyst | | CsOH | BPANa | BPANa | BPANa |
| Content of ester compound (ppm) | | glycerin | none | glycerin | glycerin |
| | | monostearate | | monostearate | monostearate |
| | | 350 | | 350 | 350 |
| content of first aromatic | | 400 | 400 | 300 | 100 |
| compound (ppm) | | | | | |
| content of second aromatic | | 1200 | 1200 | 1800 | 2500 |
| compound (ppm) | | | | | |
| content of acid (ppm) | | phosphoric acid 5 | — | phosphoric acid 5 | phosphoric acid 5 |
| content of sulfonic acid compound | | DBSP | DBSP | DBSP | DBSP |
| (ppm) | | 10 | 10 | 10 | 10 |
| content of phosphorous acid ester | | TTBPP | TTBPP | TTBPP | TTBPP |
| (ppm) | | 50 | 100 | 50 | 50 |
| characteristic | Mv | 15200 | 15200 | 15200 | 15200 |
| properties of | Mz/Mw | 1.50 | 1.50 | 1.75 | 1.50 |
| pellet | melt viscosity | <0.1% | <0.1% | <0.1% | <0.1% |
| | stability | | | | |
| | terminal OH eq/Ton | 25 | 25 | 40 | 140 |

| | | | | | | | |
|---|---|---|---|---|---|---|---|
| molding | deposit on | amount | ester compound | 180 | 0 | 180 | 140 |
| results | metal | (μg/cm²) | first aromatic | 250 | 260 | 190 | 50 |
| | mold | | compound | | | | |
| | (μg/cm²) | ratio | second aromatic | 760 | 780 | 1100 | 1100 |
| | | | compound | | | | |
| | | | first aromatic | 1.4 | 0.0 | 1.1 | 0.4 |
| | | | compound/ester | | | | |
| | | | compound | | | | |
| | | | second aromatic | 4.2 | 0.0 | 6.1 | 7.9 |
| | | | compound/ester | | | | |
| | | | compound | | | | |

| | | | | |
|---|---|---|---|---|
| critical surface tension of mold | 37.8 | 39.2 | 39.2 | 39.2 |
| surface | | | | |
| mold releasability | 0 | Impossible to | Impossible to | Impossible to |
| (defective ratio %) | | be | be | be |
| | | continuously | continuously | continuously |
| | | molded | molded | molded |
| transcription | all | Nonuniform | all | all |
| | satisfactory | in shape | satisfactory | satisfactory |
| thermal stability (ΔE) | 0.2 | 0.1 | 0.3 | 0.3 |

Ex.: Example
C.Ex.: Comparative Example
Notes)
DBSP: dodecylbenzenesulfonic acid tetrabutylphosphonium salt
TTBPP: tris(2,4-di-t-butylphenyl)phosphite

1. A polycarbonate composition comprising:
(1) 100 parts by weight of an aromatic polycarbonate which comprises (i) the main recurring unit represented by the following formula (I): 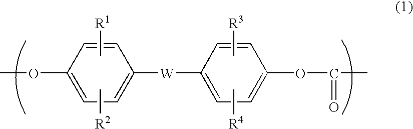
wherein R¹, R², R³ and R⁴ are each independently an alkyl group having I to 20 carbon atoms, alkoxy group having 1 to 20 carbon atoms, cycloalkyl group having 6 to 20 carbon atoms, aryl group having 6 to 20 carbon atoms, cycloalkoxy group having 6 to 20 carbon atoms or aryloxy group having 6 to 20 carbon atoms, W is a single bond, oxygen atom, carbonyl group, alkylene group having 1 to 20 carbon atoms, alkylidene group having 2 to 20 carbon atoms, cycloalkylene group having 6 to 20 carbon atoms, cycloalkylidene group having 6 to 20 carbon atoms, arylene group having 6 to 20 carbon atoms or alkylene-arylene-alkylene group having 6 to 20 carbon atoms, and which has (ii) a viscosity average molecular weight of 12,000 to 100,000, (iii) a melt viscosity stability of 0.5% or less, (iv) a terminal OH group content of 5 to 100 chemical equivalents based on 1 ton of a polymer and (v) a ratio of z average molecular weight (Mz) to weight average molecular weight (Mw) of 1.4 to 1.7;
(2) 0.005 to 0.2 part by weight of an ester of an aliphatic monocarboxylic acid having 10 to 25 carbon atoms and an aliphatic polyhydric alcohol having 2 to 10 carbon atoms; and
(3) 0.015 to 0.3 part by weight of a first aromatic compound represented by the following formula (II): 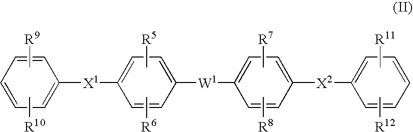
wherein R⁵, R⁶, R⁷ and R⁸ are each independently a group selected from the group consisting of hydrogen atom, alkyl group having 1 to 10 carbon atoms, aryl group having 6 to 20 carbon atoms and aralkyl group having 7 to 20 carbon atoms, R⁹, R¹⁰, R¹¹ and R¹² are each independently a group selected from the group consisting of hydrogen atom and alkyl group having 1 to 10 carbon atoms, W¹ is a member selected from the group consisting of alkylene group having 1 to 6 carbon atoms, alkylidene group having 2 to 10 carbon atoms, cycloalkylene group having 5 to 10 carbon atoms, cycloalkylidene group having 5 to 10 carbon atoms, alkylene-arylene-alkylene group having 8 to 15 carbon atoms, oxygen atom, sulfur atom, sulfoxide group and sulfone group, and X¹ and X² are each independently an ether bond (—O—), ester bond (—COO— or —OCO—) or carbonate bond (—OCOO—),
wherein the above ester is contained in the above range to ensure that when a 120 mm×50 mm board having a thickness of 2 mm is injection molded at a cylinder temperature of 380° C., a mold temperature of 80° C., an injection speed of 200 mm/sec and a holding pressure of 3,432 kPa (35 kgf/cm²), the first aromatic compound is contained in a deposit on the polymer contacting surface of a metal mold in an amount of 0.5 to 3 parts by weight based on 1 part by weight of the above ester.

2. The polycarbonate composition of claim 1 which further comprises 0.01 to 0.1 part by weight of a second aromatic compound represented by the following formula (III): 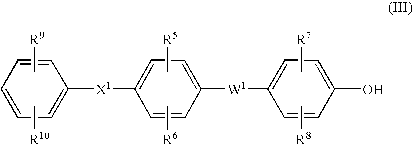
wherein R⁵ to R¹⁰, X¹ and W¹ are as defined in the above formula (II),
to ensure that the second aromatic compound is contained in the deposit on the polymer contacting surface of the metal mold in an amount of 2.5 to 10 parts by weight based on 1 part by weight of the ester when injection molding is carried out under the same conditions as above.

3. The polycarbonate composition of claim 1 or 2, wherein the aromatic polycarbonate is obtained by reacting an aromatic dihydroxy compound with a carbonic acid diester in the presence of at least one ester exchange catalyst selected from the group consisting of an alkali metal compound and an alkali earth metal compound.

4. The aromatic polycarbonate composition of claim 3, wherein the ester exchange catalyst is an alkali metal compound, and the alkali metal compound contains at least one selected from the group consisting of a cesium compound and a rubidium compound.

5. The aromatic polycarbonate composition of claim 4, wherein the alkali metal compound contains at least one selected from the group consisting of a cesium compound and a rubidium compound, and cesium and/or rubidium metal atoms account for 0.001 to 100% of the total of all the alkali metal atoms.

6. The aromatic polycarbonate composition of claim 4, wherein the alkali metal compound contains at least one selected from the group consisting of a cesium compound and a rubidium compound, and cesium and/or rubidium metal atoms account for 90 to 100% of the total of all the alkali metal atoms.

7. The aromatic polycarbonate composition of claim 1, wherein the aromatic polycarbonate contains a sulfonic acid compound represented by the following formula (IV) in an amount of 1×10⁻⁵ to 1×10⁻² part by weight based on 100 parts by weight of the aromatic polycarbonate:
A¹-So₃X¹ (IV)
wherein A¹ is a monovalent hydrocarbon group having 1 to 30 carbon atoms which may be substituted, and X¹ is an ammonium cation, phosphonium cation or monovalent hydrocarbon group having 1 to 10 carbon atoms.

8. The aromatic polycarbonate composition of claim 7, wherein the sulfonic acid compound represented by the above formula (IV) is a compound represented by the following formula (IV)-1: 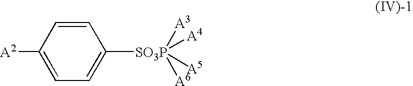
wherein A², A³, A⁴, A⁵ and A⁶ are each independently a monovalent hydrocarbon group having 1 to 20 carbon atoms.

9. The aromatic polycarbonate composition of claim 1 which comprises a phosphorous acid ester and/or a phosphoric acid ester in an amount of 1×10⁻⁴ to 0.1 part by weight based on 100 parts by weight of the aromatic polycarbonate.

10. The aromatic polycarbonate composition of claim 1 which comprises at least one compound selected from the group consisting of hydrochloric acid, phosphoric acid, phosphorous acid, boric acid, and amine salt and ammonium salt thereof in an amount of 1×10⁻⁵ to 1×10⁻² part by weight based on 100 parts by weight of the aromatic polycarbonate.

11. The aromatic polycarbonate composition of claim 1, wherein the first aromatic compound is represented by the following formula (II)-1: 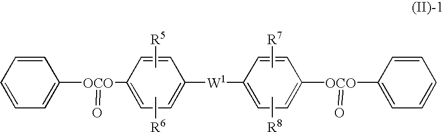
wherein R⁵ to R⁸ and W¹ are as defined in the above formula (II).

12. The aromatic polycarbonate composition of claim 2, wherein the second aromatic compound is represented by the following formula (III)-1: 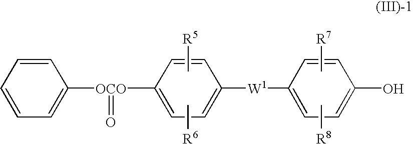
wherein R⁵ to R⁸ and W¹ are as defined in the above formula (III).

13. The aromatic polycarbonate composition of claim 1, wherein the critical surface tension measured in accordance with JIS K6768 of the polymer contacting surface of a metal mold is 32 to 39 dyne/cm when injection molding is carried out under the same conditions as above.

14. A substrate for optical recording media which is made from the aromatic polycarbonate composition of claim 1.

15. An optical recording medium comprising the substrate of claim 14 and an optical recording layer formed on one side of the substrate directly or through an intermediate layer.
